(19) United States
(12) Patent Application Publication
(10) Pub. No.: US 2026/0316605 A1
(43) Pub. Date: Oct. 15, 2026

(54) INTEGRATED CHARGER ONBOARD ELECTRIFIED CHORE PRODUCT

(71) Applicant: Briggs & Stratton, LLC, Wauwatosa, WI (US)

(72) Inventors: Jeffrey Zeiler, Brookfield, WI (US); Steven JOEHNK, Waukesha, WI (US)

(21) Appl. No.: 19/119,184

(22) PCT Filed: Oct. 13, 2023
(86) PCT No.: PCT/US2023/035100

§ 371 Date: Apr. 8, 2025

Related U.S. Application Data
(60) Provisional application No. 63/415,822, filed on Oct. 13, 2022.

(51) Int. Cl. B60L 53/16; A01D 34/64; A01D 34/78; A01D 34/81; A01D 69/02; A01D 101/00

(52) U.S. Cl. CPC B60L 53/16; A01D 34/64; A01D 34/78; A01D 34/81; A01D 69/02; A01D 2101/00; B60L 2200/40

(57) ABSTRACT

An electrified chore product includes a chassis, an energy storage device supported by the chassis, an implement, a tractive element, one or more electric motors powered by the energy storage device, a charging port configured to facilitate connecting the energy storage device to an external power source, and an integrated charger. The one or more electric motors are positioned to drive at least one of the implement or the tractive element. The integrated charger is connected between the energy storage device and the charging port.

### CROSS-REFERENCE TO RELATED PATENT APPLICATION

This application claims the benefit of and priority to U.S. Provisional Patent Application No. 63/415,822, filed Oct. 13, 2022, which is incorporated herein by reference in its entirety.

### BACKGROUND

Current trends for outdoor power equipment, including lawn mowers, include adding electrification (e.g., batteries, battery packs, electric motors, blade motors, drive/tractive motors, etc.) to replace or supplement the power that has traditionally been provided by an internal combustion engine.

### SUMMARY

One embodiment relates to an electrified chore product. The electrified chore product includes a chassis, an energy storage device supported by the chassis, an implement, a tractive element, one or more electric motors powered by the energy storage device, a charging port configured to facilitate connecting the energy storage device to an external power source, and an integrated charger. The one or more electric motors are positioned to drive at least one of the implement or the tractive element. The integrated charger is connected between the energy storage device and the charging port.

Another embodiment relates to an electrified, ride-on lawnmower. The electrified, ride-on lawnmower includes a frame and body assembly, a seat, a mower deck, a plurality of tractive elements, an energy storage device, one or more first electric motors, one or more second electric motors, a charging port, and an integrated charger. The frame and body assembly provides an operator area with a cavity beneath the operator area. The seat is disposed in the operator area, above the cavity. The mower deck is coupled to the frame and body assembly. The plurality of tractive elements are coupled to the frame and body assembly. The one or more first electric motors are powered by the energy storage device. The one or more first electric motors are positioned to drive the mower deck. The one or more second electric motors are powered by the energy storage device. The one or more second electric motors are positioned to drive one or more of the plurality of tractive elements. The charging port is configured to facilitate connecting the energy storage device to an external power source. The integrated charger is positioned within the cavity. The integrated charger is connected between the energy storage device and the charging port.

Still another embodiment relates to an electrified lawnmower. The electrified lawnmower includes a frame and body assembly providing an operator area, a mower deck coupled to the frame and body assembly, a plurality of tractive elements coupled to the frame and body assembly, an energy storage device, one or more first electric motors powered by the energy storage device, one or more second electric motors powered by the energy storage device, a charging port, and an integrated charger. The one or more first electric motors are positioned to drive the mower deck. The one or more second electric motors positioned to drive one or more of the plurality of tractive elements. The charging port is configured to facilitate connecting the energy storage device to an external power source. The integrated charger is connected between the energy storage device and the charging port. The integrated charger includes electrical circuity components such that the electrified lawnmower can receive alternating current power directly from the external power source through the charging port and, then, the integrated charger is configured to modulate the alternating current power to direct current power for storage by the energy storage device.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a schematic diagram of a chore product, according to an exemplary embodiment.

FIG. 2 is a perspective view of the chore product of FIG. 1, according to an exemplary embodiment.

FIG. 3 is a perspective view of the chore product of FIG. 1, according to another exemplary embodiment.

FIG. 4 is a detailed view of a charging port of the chore product of FIG. 1, according to an exemplary embodiment.

FIG. 5 is a detailed view of an integrated charger of the chore product of FIG. 1, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

A “chore product” as used herein refers to any type of equipment, machine, or vehicle that may be used to perform a chore (e.g., an outdoor chore, an indoor chore, lawn care, etc.). For example, a chore product may include a motor, a pump, an actuator, a compressor, and/or another device that is electrically-powered to operate some function of the chore product to facilitate performing a chore. In some embodiments, a chore is a task performed, either by a user or autonomously, at or near a household, a farm, an agricultural facility, a building, a sidewalk, a park, a parking lot, a forest, a field, and/or a lawn. In some embodiments, a chore product transports an operator and performs a chore. In some embodiments, a chore product autonomously operates to perform a chore without an operator being present on the chore product or physically/manually manipulating the chore product.

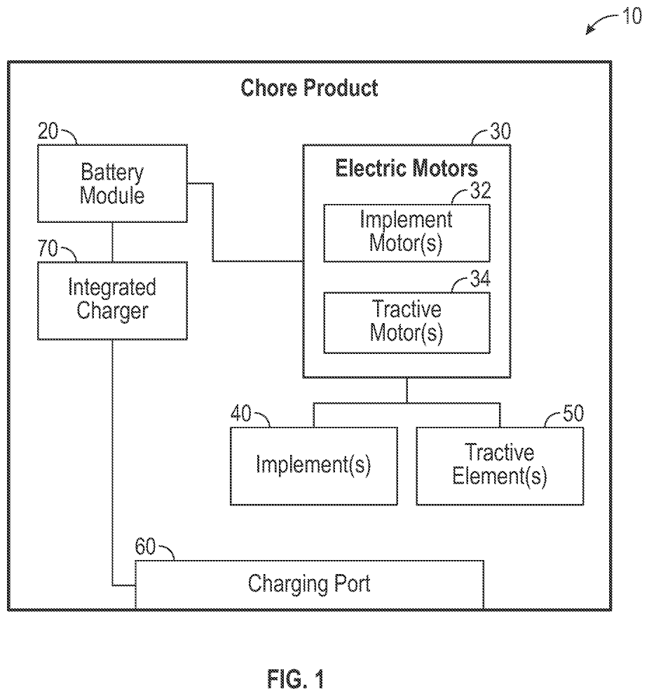

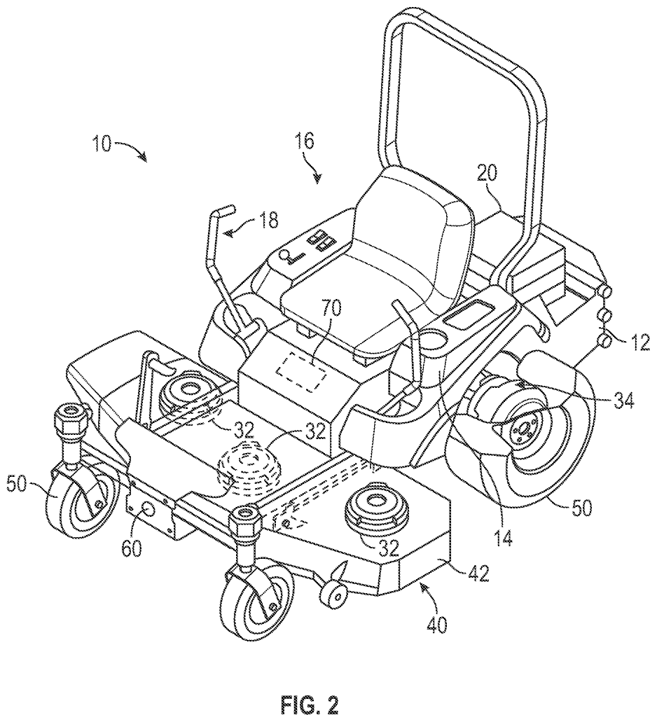

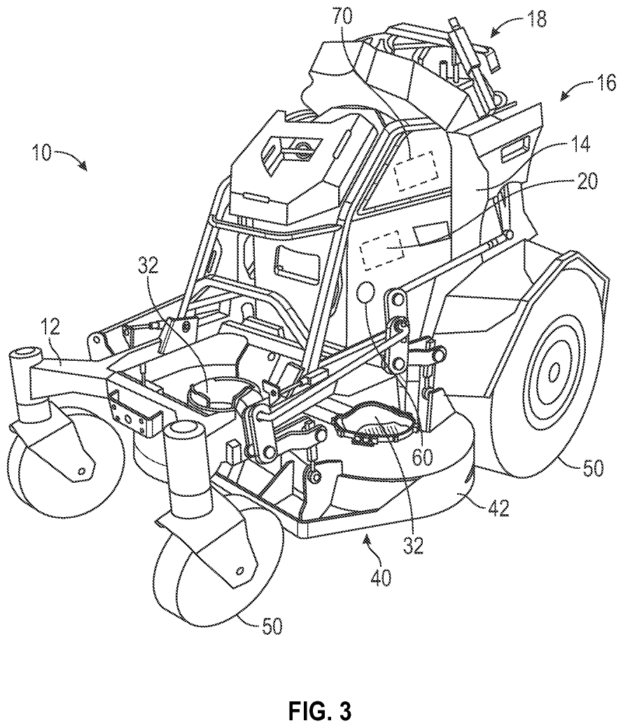

According to the exemplary embodiment shown in FIGS. 1-5, a chore product (e.g., a piece of equipment, a machine, a vehicle, outdoor power equipment, indoor power equipment, a lawn care vehicle or device, a lawn mower, etc.), shown as chore product 10, is configured as an electrified chore product. In some embodiments, the chore product 10 is an all-electric chore product (i.e., does not include an internal combustion engine). According to the exemplary embodiment shown in FIG. 2, the chore product 10 is configured as a zero turn radius (“ZTR”) mower. According to the exemplary embodiment shown in FIG. 3, the chore product 10 is configured as a stand-on mower. In some embodiments, the chore product 10 is configured as a ride-on or riding mower (i.e., a non-ZTR ride-on or riding mower). In some embodiments, the chore product 10 is configured as a walk-behind mower.

While the chore product 10 is shown to be configured as a mower, it is contemplated that the chore product 10 may be configured as or the features thereof may be implemented on other electrified chore products or “light” electrified vehicles, machines, or equipment, including outdoor power equipment, indoor power equipment, light vehicles, floor care devices, golf carts, lift trucks and other industrial vehicles, pavement surface preparation devices, recreational utility vehicles, industrial utility vehicles, lawn and garden equipment, and/or still other suitable vehicles, machines, or equipment. Outdoor power equipment may include lawn mowers, riding tractors, snow throwers, pressure washers, tillers, log splitters, walk-behind mowers, riding mowers, and turf equipment such as sod cutters, aerators, spreaders, sprayers, seeders, power rakes, and blowers. Outdoor power equipment may, for example, use one or more electric motors to drive an implement, such as a rotary blade of a lawn mower, a pump of a pressure washer, the auger of a snow thrower, the alternator of a generator, and/or a drivetrain of the outdoor power equipment. Indoor power equipment may include floor sanders, floor buffers and polishers, vacuums, etc. Recreational utility vehicles may include all-terrain vehicles (“ATVs”), utility task vehicles (“UTVs”), etc. Industrial utility vehicles may include forklifts, aircraft tugs, aerial lifts such as scissor lifts and boom lifts, etc.

As shown in FIGS. 1-5, the chore product 10 includes a chassis, shown as frame assembly 12; a chassis cover, shown as chore product body 14, positioned over and extending along a least a portion of the frame assembly 12 (e.g., a rear half thereof, a rear and/or center portion thereof, etc.); an operator area, shown as operator area 16, including various operator interfaces, shown as operator controls 18; an energy storage device (e.g., a battery bank, a battery array, etc.), shown as battery module 20, coupled to or otherwise supported by the frame assembly 12; one or more electric motors, shown as electric motors 30, including one or more first motors, shown as implement motors 32, and/or one or more second motors, shown as tractive motors 34; an implement assembly, shown as implement 40; a plurality of tractive elements, shown as tractive elements 50; a power input, shown as charging port 60; and an integrated, onboard charging circuit, shown as integrated charger 70, positioned between the battery module 20 and the charging port 60.

According to the exemplary embodiment shown in FIG. 2, the operator area 16 is a seating area that includes a seat for the operator to sit while driving or otherwise controlling operations of the chore product 10. According to the exemplary embodiment shown in FIG. 3, the operator area 16 is a stand-on area that includes a platform for the operator to stand on while driving or otherwise controlling operations of the chore product 10. In some embodiments, the operator area 16 is or includes handles or a handle bar that the operator walks behind. The operator controls 18 may include various input and/or output devices to facilitate operator control of the chore product 10 (e.g., joysticks, a steering wheel, a gear selector, a throttle or accelerator pedal, a brake lever or brake pedal, switches, knobs, displays, gauges, etc.).

As shown in FIG. 2, the battery module 20 is positioned rearward of the operator area 16 and the chore product body 14. As shown in FIG. 3, the battery module 20 is positioned underneath the chore product body 14. In other embodiments, the battery module 20 is otherwise positioned. As shown in FIG. 1, the battery module 20 is electrically coupled to and configured to power various electrical components or systems of the chore product 10 (e.g., the electric motors 30, the implement motors 32, the tractive motors 34, etc.). The battery module 20 may include a plurality of battery packs and/or cells. In some embodiments, the battery module 20 is removable. In some embodiments, the battery module 20 is rechargeable. The battery module 20 may include battery cells having one or more battery chemistries including, but not limited to, lithium ion, lithium iron phosphate, lithium polymer, nickel cadmium, lead-acid, nickel-metal hydride, and/or the like. The battery module 20 may be interchangeable between different chore products (e.g., between the chore product 10, a mower, a snow blower, a UTV, an ATV, a golf cart, an aerator, etc.). In some embodiments, the battery module 20 is removable without the use of tools. For example, the battery module 20 may be removably coupled to the chore product 10 by one or more latches, straps, detents, magnets, electrical coupler, slots, compartments, etc., or any combination thereof.

According to an exemplary embodiment, the implement motors 32 are positioned to drive one or more components of the implement 40. As shown in FIGS. 2 and 3, the implement 40 is configured as a mower implement, shown as mower deck 42, that is coupled to the frame assembly 12 and positioned in front of the chore product body 14 and the operator area 16. The mower deck 42 may include a housing or shroud with one or more cutting blades disposed therein and driven by the implement motors 32. While the mower deck 42 is shown as being positioned proximate the front of the chore product 10, in other embodiments, the mower deck 42 is positioned beneath the operator area 16 (e.g., on a ride-on or riding mower) or is trailed behind and pulled by the chore product 10. In other embodiments, the mower deck 42 is replaced or supplemented with a variety of other types of implements 40 based on the intended end use of the chore product 10 (e.g., an auger assembly for a snow blower, an aerator mechanism for an aerator, etc.). In such non-mower implementations, the implement motors 32 may drive different components than the cutting blades (e.g., blowers, spreaders, power rakes, polishers, augers, aerators, etc.).

According to an exemplary embodiment, the tractive motors 34 are positioned to drive one or more of the tractive elements 50. In some embodiments, each of the rear tractive elements 50 is independently driven by a respective tractive motor 34. In some embodiments, the rear tractive elements 50 are driven by a single tractive motor 34. In some embodiments, the front tractive elements 50 are additionally or alternatively driven by the tractive motors 34. According to the exemplary embodiment shown in FIGS. 2 and 3, the tractive elements 50 are configured as wheels. In other embodiments, the tractive elements 50 are configured as tracks.

As shown in FIG. 2, the charging port 60 is positioned along the frame assembly 12 at a front end of the chore product 10. In other embodiments, the charging port 60 is positioned along another portion of the frame assembly 12 (e.g., a rear end, a side, etc.). As shown in FIG. 3, the charging port 60 is positioned along a side of the chore product body 14. In other embodiments, the charging port 60 is positioned along another portion of the chore product body 14 (e.g., a rear end, a front end, etc.). According to an exemplary embodiment, the charging port 60 is positioned forward of and/or visible from the operator area 16 such that the operator can see whether the chore product 10 is plugged in (e.g., thereby preventing driving off while the chore product 10 is still plugged in). In one embodiment, the charging port 60 is positioned along an arm rest of the operator area 16.

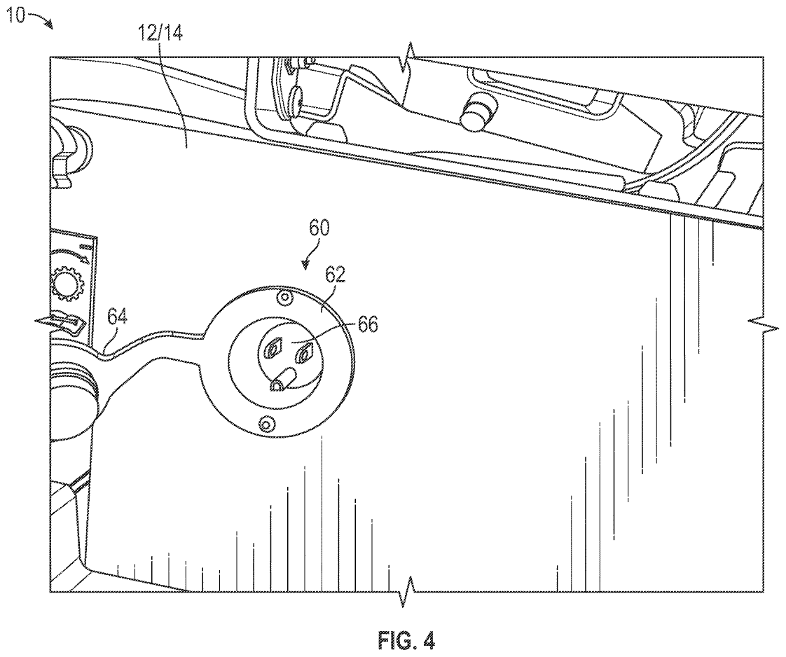

As shown in FIG. 4, the charging port 60 includes a housing, shown as charging housing 62, recessed into the frame assembly 12 or the chore product body 14; a cover, shown as charging port cover 64, that facilitates selectively enclosing the charging housing 62; and a connector, shown as electrical connector 66, disposed within the charging housing 62. According to an exemplary embodiment, the electrical connector 66 is a male connector that facilitates electrically connecting the integrated charger 70 and the battery module 20 to a female connector of a charging cord external to the chore product 10. By way of example, the electrical connector 66 may be a U.S. style male power connector or plug (e.g., a type B male connector or plug). By way of another example, the electrical connector 66 may be another type of male connector (e.g., a Type A, a Type C, a Type D, etc. male connector or plug). In some embodiments, the electrical connector 66 is configured to interface with and receive power directly from traditional lower voltage alternating current (e.g., 110 VAC, 120VAC, 220VAC, 240VAC, etc.) power systems without any filtering, conversion, inversion, transformation, modulation, manipulation, etc. of the power before reaching the chore product 10.

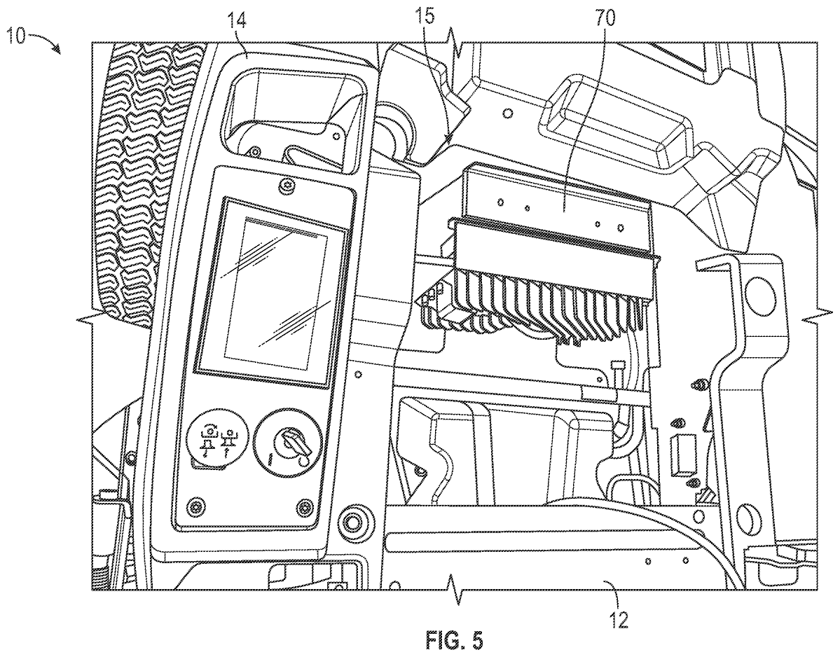

As shown in FIG. 5, the integrated charger 70 is disposed within a cavity, shown as internal compartment 15, defined by the frame assembly 12 and/or the chore product body 14 (e.g., under the operator area 16, etc.). As shown in FIG. 5, the integrated charger 70 includes various protrusions or fins. Such fins permit heat exchange to facilitate cooling the integrated charger 70 (e.g., as air flows therethrough). During regular operation, however, the fins may become dirty or otherwise covered with debris, which can adversely impact the charging capabilities of the integrated charger 70. According to an exemplary embodiment, the internal compartment 15 is semi-enclosed to mitigate or reduce the amount of dirt or debris that reaches the integrated charger 70. According to an exemplary embodiment, the internal compartment 15 is easily accessible (e.g., by a liftable/pivotable panel, seat, etc.) such that the integrated charger 70 is readily accessible to facilitate easy access, cleaning, and maintenance to ensure optimum and efficient operation thereof.

According to an exemplary embodiment, the integrated charger 70 includes various electrical circuity components (e.g., transformers, inverters, converters, etc.) such that the chore product 10 can receive alternating current power directly from an external power source (e.g., a mains power source, etc.) through the charging port 60 and, then, the integrated charger 70 is configured to modulate/manipulate (e.g., convert, step down, etc.) the alternating current power to direct current power for storage by the battery module 20 and/or to power electrical components on the chore product 10 that operate using direct current power.

Advantageously, the charging port 60 and the integrated charger 70 being positioned onboard the chore product 10 facilitates directly connecting the chore product 10 with an external power source (e.g., a mains power source, a wall outlet, a generator, etc.) using a standard extension cord and without requiring special charging cables or systems external to the chore product 10 that traditional electrified power tools and equipment would otherwise require. Accordingly, operators do not need to make sure that a specifically designed charging cable is kept with the chore product 10 or kept track off at all times. Rather, any suitable and available extension cord may be used to directly interface with the electrical connector 66 of the charging port 60 to connect the chore product 10 directly to the external power source and charge the battery module 20.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the chore product 10 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. An electrified chore product comprising:
a chassis;
an energy storage device supported by the chassis;
an implement;
a tractive element;
one or more electric motors powered by the energy storage device, the one or more electric motors positioned to drive at least one of the implement or the tractive element;
a charging port configured to facilitate connecting the energy storage device to an external power source; and
an integrated charger connected between the energy storage device and the charging port.

2. The electrified chore product of claim 1, wherein the charging port is positioned at a front end of the electrified chore product.

3. The electrified chore product of claim 1, further comprising an operator area, wherein the charging port is positioned forward of and visible from the operator area.

4. The electrified chore product of claim 3, wherein the operator area includes a seat, and wherein the integrated charger is positioned within a cavity beneath the seat.

5. The electrified chore product of claim 4, wherein the integrated charger includes a plurality of protrusions or fins, and wherein the cavity is at least partially enclosed to mitigate or reduce an amount of dirt or debris that reaches the integrated charger.

6. The electrified chore product of claim 5, wherein the seat is movable such that the integrated charger is readily accessible.

7. The electrified chore product of claim 1, wherein the charging port includes an electrical connector that facilitates electrically connecting the integrated charger and the energy storage device to a charging cord external to the electrified chore product and connected to the external power source without any filtering, conversion, inversion, transformation, modulation, or manipulation of alternating current power received from the external power source before reaching the electrified chore product.

8. The electrified chore product of claim 7, wherein the electrical connector is a male connector configured to interface with a female connector of the charging cord.

9. The electrified chore product of claim 8, wherein the charging cord is a standard extension cord.

10. The electrified chore product of claim 7, wherein the integrated charger includes electrical circuity components such that the electrified chore product can receive the alternating current power directly from the external power source through the charging port and, then, the integrated charger is configured to modulate the alternating current power to direct current power for storage by the energy storage device.

11. The electrified chore product of claim 7, wherein the charging port includes a housing and a cover that facilitates selectively enclosing the housing, and wherein the electrical connector is disposed within the housing.

12. The electrified chore product of claim 1, wherein the electrified chore product is a lawnmower, and the implement is a mower deck.

13. The electrified chore product of claim 12, wherein the lawnmower is a ride-on mower.

14. An electrified, ride-on lawnmower comprising:
a frame and body assembly providing an operator area with a cavity beneath the operator area;
a seat disposed in the operator area, above the cavity;
a mower deck coupled to the frame and body assembly;
a plurality of tractive elements coupled to the frame and body assembly;
an energy storage device;
one or more first electric motors powered by the energy storage device, the one or more first electric motors positioned to drive the mower deck;
one or more second electric motors powered by the energy storage device, the one or more second electric motors positioned to drive one or more of the plurality of tractive elements;
a charging port configured to facilitate connecting the energy storage device to an external power source; and
an integrated charger positioned within the cavity, the integrated charger connected between the energy storage device and the charging port.

15. The electrified, ride-on lawnmower of claim 14, wherein the charging port is positioned forward of and visible from the operator area.

16. The electrified, ride-on lawnmower of claim 14, wherein the integrated charger includes a plurality of protrusions or fins, and wherein the cavity is at least partially enclosed to mitigate or reduce an amount of dirt or debris that reaches the integrated charger.

17. The electrified, ride-on lawnmower of claim 16, wherein the seat is movable such that the integrated charger is readily accessible.

18. The electrified, ride-on lawnmower of claim 14, wherein the charging port includes an electrical connector that facilitates electrically connecting the integrated charger and the energy storage device to a charging cord external to the electrified, ride-on lawnmower product and connected to the external power source without any modulation of alternating current power received from the external power source before reaching the electrified, ride-on lawnmower.

19. The electrified, ride-on lawnmower product of claim 18, wherein the integrated charger includes electrical circuity components such that the electrified, ride-on lawnmower can receive the alternating current power directly from the external power source through the charging port and, then, the integrated charger is configured to modulate the alternating current power to direct current power for storage by the energy storage device.

20. An electrified lawnmower comprising:
a frame and body assembly providing an operator area;
a mower deck coupled to the frame and body assembly;
a plurality of tractive elements coupled to the frame and body assembly;
an energy storage device;
one or more first electric motors powered by the energy storage device, the one or more first electric motors positioned to drive the mower deck;
one or more second electric motors powered by the energy storage device, the one or more second electric motors positioned to drive one or more of the plurality of tractive elements;
a charging port configured to facilitate connecting the energy storage device to an external power source; and
an integrated charger connected between the energy storage device and the charging port, wherein the integrated charger includes electrical circuity components such that the electrified lawnmower can receive alternating current power directly from the external power source through the charging port and, then, the integrated charger is configured to modulate the alternating current power to direct current power for storage by the energy storage device.
